(19) United States
(12) Patent Application Publication
(10) Pub. No.: US 2006/0037033 A1
(43) Pub. Date: Feb. 16, 2006

(54) Recording and/or reproducing apparatus and method releasing a medium

(75) Inventor: Hwan-seung Lee, Yongin-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 11/200,196

(22) Filed: Aug. 10, 2005

(30) Foreign Application Priority Data
Aug. 11, 2004 (KR) 2004-63216

(51) Int. Cl. G11B 17/04

(52) U.S. Cl. 720/622

(57) ABSTRACT

A recording and/or reproducing apparatus including a disc releasing apparatus/method. The disc releasing apparatus separates a disc guide lever from an inserted disc, with the disc guide lever being mounted to a main chassis, to selectively guide discs of different sizes. The disc releasing apparatus may include a gear cam, rotatably mounted to the main chassis, a locking lever operating in association with the gear cam to selectively lock and release the disc guide lever, and a releasing lever operating in association with the gear cam to separate the disc guide lever from the disc.

### CROSS-REFERENCE TO RELATED APPLICATIONS

This application claims the benefit of Korean Patent Application No. 2004-63216, filed Aug. 11, 2004, in the Korean Intellectual Property Office, the disclosure of which is incorporated herein by reference.

### BACKGROUND OF THE INVENTION

1. Field of the Invention

Embodiments of the present invention relate to a recording and/or reproducing apparatus and method. More particularly, embodiments of the present invention relate to a reproducing and/or recording apparatus/method including a medium releasing apparatus/method separating a guide member guiding the loading/unloading of media of different sizes.

2. Description of the Related Art

Generally, a recording and/or reproducing apparatus, e.g., a disc drive, records and/or reproduces information to/from media, e.g., a compact disc (CD), a compact disc read-only-memory (CD-ROM), digital video disc (DVD) and a DVD-ROM, for example. To this end, such a disc drive may include a releasing apparatus separating a guide member from a disc put on a chucking position, i.e., a position permitting manipulation of the disc for the recording and/or reproducing information, after the guide member loads the disc to the chucking position.

Similarly, after being loaded to such a turntable, for rotating the disc, the disc separated from the guide member by the releasing apparatus may be clamped by a chucking unit and rotated. During the rotation of the disc on the turntable, an optical pickup may move in a radial direction of the disc to record or reproduce information to/from the disc.

However, conventional disc releasing apparatuses requires a lot of power to release the guide member from the disc, as a result of a large number of component parts having a complicated structure. Also, in the conventional disc releasing apparatus, loss of power and malfunctions frequently occur. In addition, due to the complicated structure and the large number of parts, a bulky size of the apparatus is inevitable. As a result, it is desirable for researchers to attempt to implement an improved releasing apparatus capable of operating with fewer component parts and accordingly implement a compact-sized disc drive.

### SUMMARY OF THE INVENTION

An aspect of the present invention is to solve at least the above problems and/or disadvantages and to provide at least the advantages described below. Accordingly, an aspect of the present invention is to provide a disc releasing apparatus/method having a simplified structure with a reduced number of component parts, and a disc drive having the same.

To achieve the above and/or other aspects and advantage, embodiments of the present invention set forth a medium releasing apparatus to separate a medium guide lever from a medium, the medium guide lever selectively capable of guiding differing sized media, the medium releasing apparatus including a rotatably mounted gear cam, a locking lever operating in association with the gear cam to selectively lock and release the medium guide lever, and a releasing lever operating in association with the gear cam to separate the medium guide lever from the medium.

Here, the gear cam may be rotatably mounted on a main chassis in a recording and/or reproducing apparatus, and the medium guide lever may also be mounted on the main chassis of a recording and/or reproducing apparatus. Further, the medium may be a disc.

The gear cam may include at least one cam projection part, a guide slot to connect with the releasing lever, and an outer projection part to obstruct movement of the locking lever. In addition, the locking lever may include a locking projection to be pressed by the outer projection part. The locking lever may also be elastically biased by an elastic member which is connected to a main chassis of a recording and/or reproducing apparatus.

The releasing lever may further include a guide pin to move along a path of the guide slot, and a releasing projection to inserted in the medium guide lever.

To achieve the above and/or other aspects and advantage, embodiments of the present invention set forth a recording and/reproducing apparatus to load and/or unload at least first and second mediums, the medium loading apparatus including a main chassis to mount a transfer unit to move the first or second medium, a power transmission unit including a driving motor to transmit power to the transfer unit, a slider, to be transmitted with the power from the power transmission unit, and movable in directions for loading and/or unloading the first or second medium, a medium guide lever to be pushed by the first or second medium, thereby guiding the first or second medium, a pushing lever to connect the slider to the power transmission unit, in association with the medium guide lever, and a locking/releasing unit to selectively lock and/or separate the medium guide lever from connection with the medium.

The locking/releasing unit may include a gear cam rotatably mounted to the main chassis and rotated by a reciprocal movement of the pushing lever in connection with the slider, a locking lever rotatably mounted to the main chassis and associated with the medium guide lever and the gear cam so as to selectively lock and/or release the medium guide lever, and a releasing lever rotatably mounted to the main chassis and associated with the gear cam so as to separate the medium guide lever from the first or second medium.

In addition, the medium guide lever may include at least one medium guide projection for guiding the first or second medium by contact with the first or second medium, and moves among an initial position where the medium guide projection has not yet contacted with the first or second medium, an intermediate position where the medium guide projection pushes the first or second medium to a chucking position and a separate position, where the medium guide lever is separated from the first or second medium being in the chucking position, by a predetermined distance. The medium guide lever may include a position controlling groove, and the locking lever may include a position controlling projection for insertion into the position controlling groove, such that the locking lever locks the medium guide lever.

The slider may include a cam recess part, and the gear cam may include at least one cam projection part for insertion into the cam recess part of the slider, a gear cam guide slot including a predetermined path therein, and an outer projection part formed along an outside of the gear cam slot. The locking lever may further include a locking projection pushed by the outer projection part by rotation of the gear cam, and accordingly, the locking lever may be rotated so that the position controlling projection is separated from the position controlling groove of the medium guide lever. The releasing lever may further include a guide pin moving along the path of the guide slot by rotation of the gear cam. The medium guide lever may still further include a releasing groove, the releasing lever may include a releasing projection for insertion in the releasing groove, and the releasing lever may be rotated by the movement of the guide pin such that the releasing projection is inserted in the releasing groove.

In addition, the second medium may have a larger width than the first medium.

To achieve the above and/or other aspects and advantage, embodiments of the present invention set forth a medium releasing method separating a medium guide lever from a medium, the medium guide lever selectively guiding differing sized media, the medium releasing method including rotating a gear cam, selectively locking and releasing the medium guide lever using a locking lever operating based on the rotating of the gear cam, and separating the medium guide lever from the medium using a releasing lever based on the rotating of the gear cam.

Additional aspects and/or advantages of the invention will be set forth in part in the description which follows and, in part, will be apparent from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 illustrates a plan view of a disc loading apparatus of a disc drive, according to an embodiment of the present invention;

FIG. 2 illustrates a side view of a disc loading apparatus of a disc drive, according to an embodiment of the present invention;

FIG. 3 illustrates a loading operation of a first disc in a disc drive, such as in the disc drive of FIG. 1;

FIG. 4 illustrates a releasing operation of the first disc, such as in disc drive of FIG. 1;

FIG. 5 illustrates a loading operation of a second disc, such as in the disc drive of FIG. 1; and

FIG. 6 illustrates a releasing operation of a second disc, such as in the disc drive of FIG. 1.

### DETAILED DESCRIPTION OF THE PREFERRED EMBODIMENTS

Reference will now be made in detail to embodiments of the present invention, examples of which are illustrated in the accompanying drawings, wherein like reference numerals refer to the like elements throughout. The embodiments are described below to explain the present invention by referring to the figures.

In addition, matters defined in the description such as a detailed construction and elements are provided mainly to assist in a comprehensive understanding of the invention, and it should be understood that the present invention can be carried out without those defined matters, or with different arrangements of the same.

As will be described herein, a first disc 1 will be considered to be a general 80mm disc, and a second disc 2 will be considered to be a 120 mm disc, noting that embodiments of the present invention are not limited thereto. A disc loading apparatus according to an embodiment of the present invention is described herein for a slot-in type disc drive capable to load discs of different sizes without a disc tray, for example.

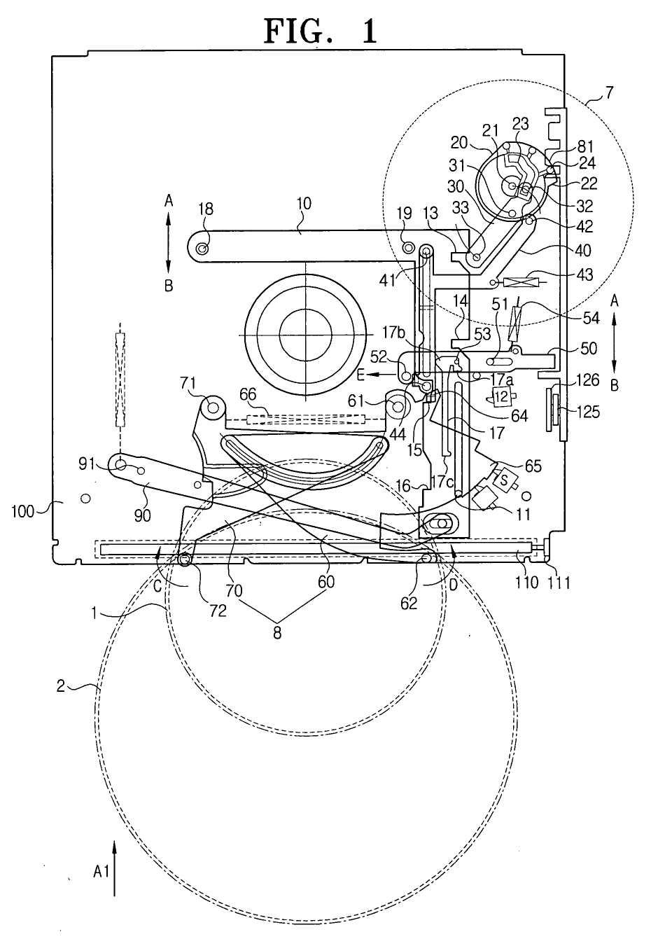

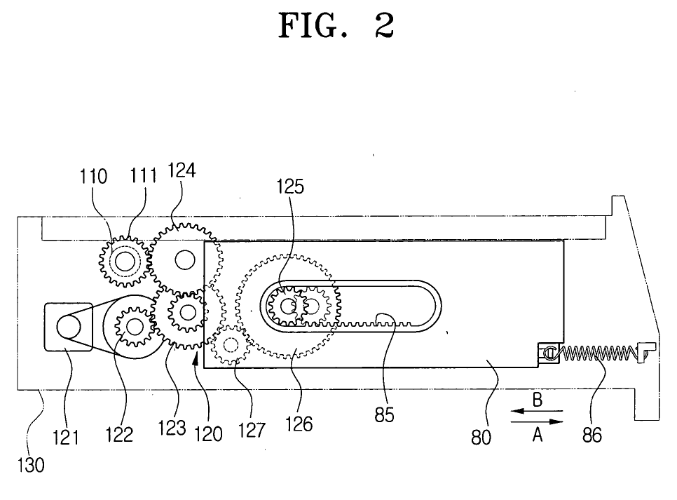

Referring to FIGS. 1 and 2, the disc loading apparatus for a disc drive, according to an embodiment of the present invention, can include a main chassis 100 having a transfer roller 110, a power transmission unit 120, a slider 80, a disc guide lever 10, a pushing lever 50, a releasing apparatus 7, a door unit 8 and a double insertion prevention lever 90.

The transfer roller 110 may be rotated by power transmitted from the power transmission unit 120, thereby moving inward a disc inserted from a front of the disc drive, specifically, from a lower part of the main chassis 100, for example, and/or discharging outward a disc in the disc drive. The transfer roller 110 can be supported by a hinge unit (not shown) at both ends thereof. The hinge unit (not shown) can also be pivotably mounted to the main chassis. As the hinge unit pivots in association with the slider 80, the transfer roller 110 may be brought into contact with or distanced away from the disc being inserted or discharged.

The main chassis 100 can be mounted along an upper part of a housing 130 mounting an optical pickup (not shown). The main chassis 100 may further include a chucking device (not shown) for chucking, on a turntable (not shown), the discs 1 and 2 after being transferred to a chucking position.

The power transmission unit 120 can include a driving motor 121 mounted in the housing 130, a plurality of connection gears 122, 123 and 124 for transmitting the power of the driving motor 121 to a slave gear 111 connected to the transfer roller 110, a driving gear 125 selectively connected to a rack gear 85 provided to the slider 80, and a main gear 126 connected to the driving gear 125, for example. A simple connection gear 127 can interconnect the main gear 126 and the connection gear 123. In addition, the driving motor 121 may bidirectionally rotate to selectively rotate the transfer roller 110 bidirectionally. The driving motor 121 may also move the slider 80 forward and backward with respect to a loading direction of the disc.

The slider 80, connected to the main chassis 100, can reciprocate in directions for loading and unloading the inserted discs 1 and 2. The slider 80 may include the rack gear 85 having a predetermined length. The rack gear 85 can initially be distanced from the driving gear 125 until one of the discs 1 and 2 are loaded, up to the chucking position. The slider 80 may also be elastically biased by a spring 86 in an ‘A’ direction. When one of the first and the second discs 1 and 2 are loaded, the slider 80 can be pushed by the pushing lever 50, thereby connecting the slider 80 to the driving gear 125.

When one of the first and the second discs 1 and 2 are inserted into the housing 130 by the transfer roller 110, the disc guide lever 10 can guide the inserted disc to the chucking position, that is, an intermediate position. The disc guide lever 10 may include disc guide projections 18 and 19, respective first and second position controlling grooves 15 and 16, a cam slot 17, respective first and second releasing grooves 13 and 14, and a disc guide lever guide slot 11.

As shown in FIG. 1, the pair of disc guide projections 18 and 19 are formed on opposite ends of an upper side of the disc guide lever 10, so that the discs 1 and 2 being transferred by the transfer roller 110 can be located on the chucking position through contact with the disc guide projections 18 and 19. The first and the second position controlling grooves 15 and 16 are formed on one end of a vertical part of the disc guide lever 10 at a predetermined distance from each other, while the first and the second releasing grooves 13 and 14 are formed on the other end of the vertical part of the disc guide lever 10 at a predetermined distance from each other.

The cam slot 17 and the disc guide lever guide slot 11 are formed along the center of the vertical part of the disc guide lever 10. The cam slot 17 is formed in a length direction of the vertical part of the disc guide lever 10 and can include a first slot 17a formed at one end thereof, a second slot 17c formed at the other end, and a third slot 17b formed on a moving path for the first and the second slot 17a and 17c.

The pushing lever 50 can rotate with respect to a pushing lever rotary shaft 51 by a predetermined angle, on the main chassis 100, and may include a stopper projection 52, a stopper boss 53 and a first elastic member 54. In association with a movement of the disc guide lever 10, the pushing lever 50 can move the slider 80 to connect the slider 80 with the power transmission unit 120.

The stopper boss 53 can be formed in the center of the pushing lever 50 to be inserted in the cam slot 17 of the disc guide lever 10. Similarly, the stopper projection 52 can be provided along one side of the pushing lever 50 for association with a position controlling projection 44 of a locking lever 40. The first elastic member 54 interconnects the pushing lever 50 and the main chassis 100, and returns the pushing lever 50, pivoted by the disc guide lever 10, to an initial position.

A releasing apparatus 7 can include a gear cam 20, the locking lever 40, and a releasing lever 30. The releasing apparatus 7 can operate in association with the guide lever 10 and the slider 80 to selectively lock and unlock the disc guide lever 10 and distance the disc guide lever 10 from one of the discs 1 or 2 located on the chucking position.

The gear cam 20 can rotate with respect to a gear cam rotary shaft 21 by a predetermined angle, on the main chassis, and can include an outer projection part 22, a gear cam guide slot 23, and a plurality of cam projection parts 24. The plurality of cam projection parts 24 can be inserted into cam recess parts 81 of the slider 80 and move in association with the slider 80, moving in the ‘B’ direction, thereby rotating the gear cam 20 in the ‘C’ direction. The outer projection part 22 can, thus, push the locking projection 42 of the locking lever 40 when the gear cam 20 rotates, and accordingly, the locking lever 50 may then rotate with respect to a locking lever rotary shaft 41, in the ‘C’ direction. When the gear cam 20 rotates, the gear cam guide slot 23 can guide a movement of a guide pin 32 of the releasing lever 30, being inserted in the gear cam guide slot 23, so that the releasing lever 30 rotates with respect to the releasing lever 30, in the ‘C’ direction.

The locking lever 40 can rotate by a predetermined angle, with respect to the locking lever rotary shaft 41 on the main chassis 100, and may include the locking projection 42, a second elastic member 43, and the position controlling projection 44. When the gear cam 20 rotates, the locking projection 42 can be obstructed by the rotated outer projection part 22, and accordingly, moved in the ‘C’ direction (FIG. 1), with respect to the locking lever rotary shaft 41. The position controlling projection 44 can be inserted in the first position controlling groove 15 when the first disc 1 is used and inserted in the second position controlling grooves 16 when the second disc 2 is used, for example, so as to lock the disc guide projection 10. The second elastic member 43 connecting the locking lever 40 and the main chassis 100 can bias the locking lever 40 toward a locking position.

The releasing lever 30 rotates by a predetermined angle, with respect to the releasing lever rotary shaft 31 on the main chassis 100, and may include the guide pin 32 and a releasing projection 33. The releasing lever 30 can operate in association with the gear cam 20 to distance the disc guide lever 10, released from the chucking area, from the first and the second discs 1 and 2, for example.

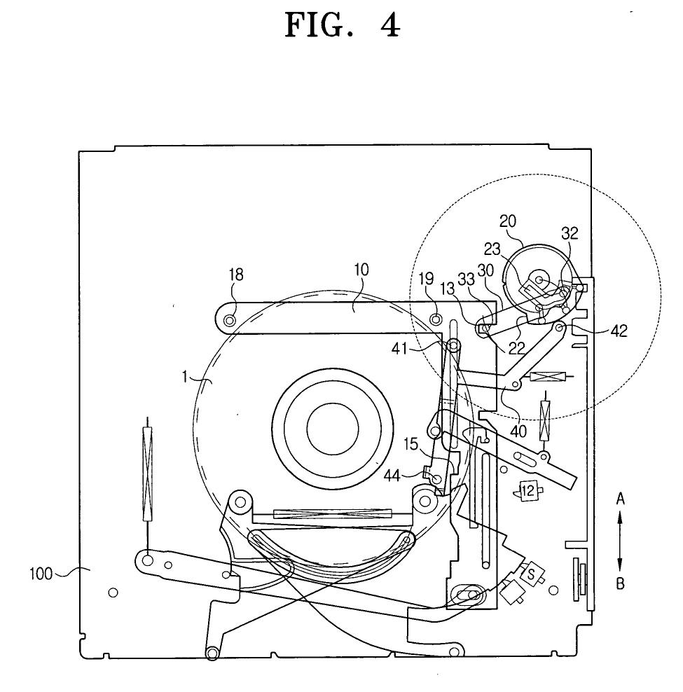

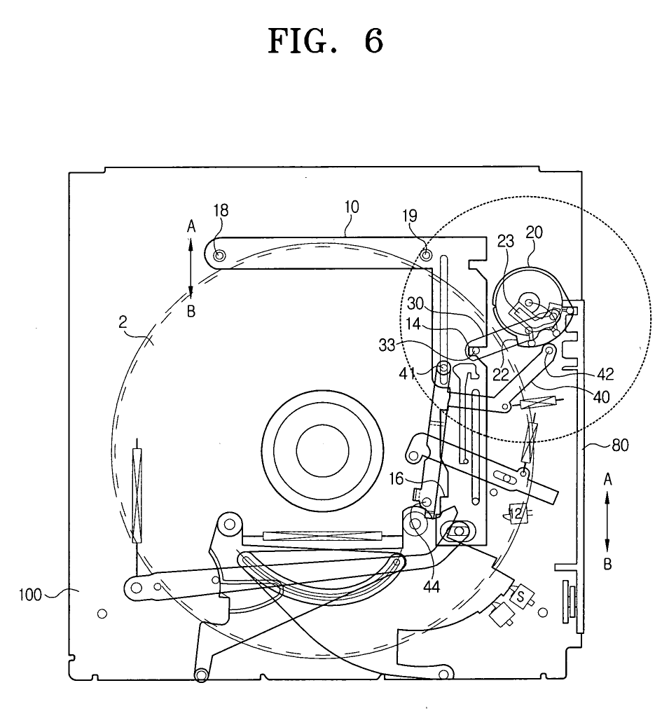

The guide pin 32 can be inserted in the gear cam guide slot 23 of the gear cam 20 for the operation of the releasing lever 30, in association with the rotation of the gear cam 20. Therefore, the releasing lever 30 can rotate with respect to the releasing lever rotary shaft 31 in the ‘C’ direction (as shown in FIGS. 4 and 6), and the releasing projection 33 may be inserted in the first releasing groove 13 when the first disc 1 is used or inserted in the second releasing groove 14 when the second disc 2 is used, for example.

The door unit 8 drives the driving motor 121 to contact a starting switch S when one of the discs 1 and 2 are inserted, and may include a first door lever 60 and a second door lever 70. The first and the second door levers 60 and 70 can be mounted on the main chassis 100 to rotate with respect to first and second door lever rotary shafts 61 and 71 thereof by a predetermined angle, and elastically biased by connection with a third elastic member 66, for example. The first and the second door levers 60 and 70 respectively may include first and second door projections 62 and 72, with the first and the second door projections 62 and 72 being biased in contact with the disc 1 or 2 toward the loading direction while the disc 1 or 2 is inserted into the housing 130.

When one of the discs 1 and 2 is in operation in the housing 130, the double insertion prevention lever 90 can prevent insertion of another disc, e.g., the other of the discs 1 and 2. The double insertion prevention lever 90 can be mounted on the main chassis 100 and rotate with respect to a double insertion prevention lever rotary shaft 91 by a predetermined angle.

Hereinbelow, operations for loading and releasing disc, according to an embodiment of the present invention, will be described in greater detail.

First, an operation for loading the first disc 1, which will be considered a 80mm disc herein for merely convenience of explanation, is as follows.

As shown in FIG. 1, the first disc 1 can be inserted into the housing 130 in an ‘A1’ direction, that is, a loading direction. The disc guide lever 10 can be in an initial state where it is not obstructed by the first disc 1. The inserted first disc 1 can then push the first and the second door levers 60 and 70 into contact with the first and the second door projections 62 and 72. The first and the second door levers 60 and 70 may then rotate with respect to the first and the second door lever rotary shafts 61 and 71 in respective ‘D’ and ‘C’ directions, thereby being distanced from each other. A protruded cam 65 of the first door lever 60 can contact the starting switch S, thereby operating the driving motor 121 (shown in FIG. 2). Accordingly, the transfer roller 110 rotates, and the first disc 1 can be drawn into the housing 130 by the transfer roller 110.

The first disc 1 can be brought into contact with both disc guide projections 18 and 19 of the disc guide lever 10. By continuous rotation of the transfer roller 110, the first disc 1 accordingly moves the disc guide lever 10 in the ‘A’ direction.

As the disc guide lever 10 is moved in ‘A’ direction, the first slot 17a of the cam slot 17 contacts and pushes the stopper boss 53 of the pushing lever 50. Therefore, the pushing lever 50 rotates about the pushing lever rotary shaft 51 in the ‘C’ direction, thereby pushing the slider 80, with one end thereof, in the ‘B’ direction by a predetermined distance.

When the slider 80 is pushed by a predetermined distance, the rack gear 85 comes into connection with the driving gear 125, as shown in FIG. 2. The power of the driving gear 125 can then be transmitted to the rack gear 85, and therefore, the slider 80 can be kept moving in the ‘B’ direction.

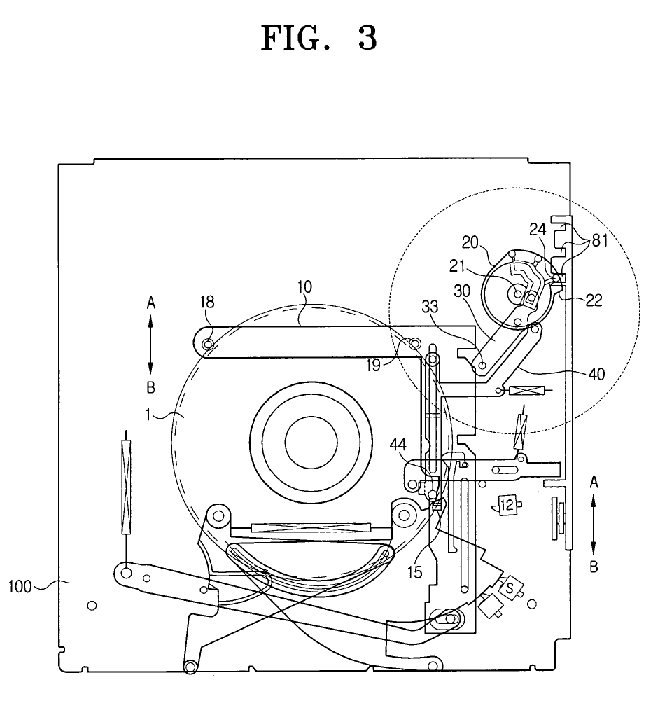

FIG. 3 illustrates the disc guide lever 10 in an intermediate position. Referring to FIG. 3, the first disc 1, being moved in the ‘A’ direction and pushing the disc guide lever 10, can be guided by the disc guide projections 18 and 19 up to the chucking position. The chucking position can be controlled in a manner that the first position controlling groove 15 of the disc guide lever 10 is hitched by the position controlling projection 44 of the locking lever 40. More specifically, as the first position controlling groove 15 is hitched by the position controlling projection 44, the disc guide lever 10 may not move further upward in the ‘A’ direction. Accordingly, the first disc 1 may not move farther either, and this position of the first disc 1 can be considered to be at the chucking position. When the first disc 1 reaches the chucking position, a dedicated chucking device can thereafter perform the chucking operations.

As described above, the slider 80 can keep moving in the ‘B’ direction even after the chucking operation. As a result, the cam projection part 24, inserted in the cam recess parts 81 of the slider 80, rotates in the ‘C’ direction, thereby rotating the gear cam 20 with respect to the gear cam rotary shaft 21 in the ‘C’ direction, for example.

FIG. 4 shows the disc guide lever 10 in a separated position from the disc 1. Referring to FIG. 4, as the gear cam 20 rotates, the outer projection part 22 of the gear cam 20 can push the locking projection 42 of the locking lever 40, thereby rotating the locking lever 40, with respect to the locking lever rotary shaft 41, in the ‘C’ direction. Consequently, the position controlling projection 44 can be separated from the first position controlling groove 15 of the disc guide lever 10.

Also, as the gear cam 20 rotates, the guide pin 32 of the releasing lever 30, inserted in the gear cam guide slot 23 of the gear cam 20, moves along the gear cam guide slot 23, and therefore, the releasing lever 30 is rotated with respect to the releasing lever rotary shaft 31 in the ‘C’ direction. Accordingly, the releasing projection 33 of the releasing lever 30 is inserted into the first releasing groove 13 of the disc guide lever 10. If the gear cam 20 makes more rotation in the ‘C’ direction, by a predetermined angle, the disc guide lever 10 can thus be moved further in the ‘A’ direction, thereby separating from the first disc 1.

When the disc guide projections 18 and 19 of the disc guide lever 10 are distanced from the first disc 1, the first disc 1, thereafter, becomes rotatable on the turntable (not shown), being chucked by the dedicated chucking device (not shown). Thus, loading of the first disc 1 is completed, and the first disc 1 can rotate on the turntable to record or reproduce information by the optical pickup. Such subsequent recording and/or reproduction of data to/from the disc 1 can be implemented using conventional systems of the disc drive, with such conventional systems not being illustrated herein for simplification of explaining aspects of the present invention.

For unloading of the first disc 1, the driving motor 121 (shown in FIG. 2) can be counter-rotated to return the slider 80 in the ‘A’ direction. By performing similar processes, in reverse order, the first disc 1 can be unloaded and discharged to the outside of the housing 130.

Hereinbelow, a description will be made with regard to the operation for loading the second disc 2, which will be considered a 120 mm disc herein for merely convenience of explanation, noting that embodiments of the present invention are not limited thereto

In the operation for loading the second disc 2, a main difference from the loading operation for the first disc 1 is that the disc guide lever 10 for guiding the second disc 2 to the chucking position is moved further in the ‘A’ direction, for example, based on the diameter of the second disc 2 being greater than that of the first disc 1.

More specifically, the second disc 2 can be inserted into the housing 130, in ‘A1’ direction, that is, the loading direction with the disc guide lever 10 in the initial state, as shown in FIG. 1. The inserted second disc 2 can push the first and the second door levers 60 and 70, contacting respective the first and the second door projections 62 and. The first and the second door levers 60 and 70 can be rotated with respect to the first and the second door lever rotary shafts 61 and 71 in the ‘C’ and ‘D’ directions, respectively, thereby being distanced from each other. The protruded cam 65 of the first door lever 60 can then contact the starting switch S, thereby operating the driving motor 121 (shown in FIG. 2). Accordingly, the transfer roller 110 can rotate, and the second disc 2 can be drawn into the housing 130 by the transfer roller 110.

The second disc 2 can be brought into contact with the disc guide projections 18 and 19 of the disc guide lever 10. By continuous rotation of the transfer roller 110, the second disc 2 moves the disc guide lever 10 in the ‘A’ direction.

When the second disc 2 is inserted, due to the increased diameter of the second disc 2, the first door lever 60 may be rotated, with respect to the first door lever rotary shaft 61, in the ‘D’ direction by a greater degree than when rotated during the first disc 1 insertion. The position controlling projection 44 of the locking lever 40, in association with the pushing projection 64 of the first door lever 60, then pushes the stopper projection 52 of the pushing lever 50, in the ‘E’ direction. Accordingly, the stopper boss 53 of the pushing lever 50 comes close to the third slot 17b of the cam slot 17, and as the disc guide lever 10 moves in the ‘A’ direction, the stopper boss 53 is then hitched by the second slot 17c of the cam slot 17. As the disc guide lever 10 is moved in the ‘A’ direction, the second slot 17c of the cam slot 17 pushes the stopper boss 53 of the pushing lever 50. Therefore, the pushing lever 50 is rotated, with respect to the pushing lever rotary shaft 51, in the ‘C’ direction, thereby pushing the slider 80 in the ‘B’ direction by a predetermined distance.

When the slider 80 is pushed the predetermined distance, the rack gear 85 comes into connection with the driving gear 125, as shown in FIG. 2. The power of the driving gear 125 can then be transmitted to the rack gear 85, and therefore, the slider 80 can be kept moving in the ‘B’ direction.

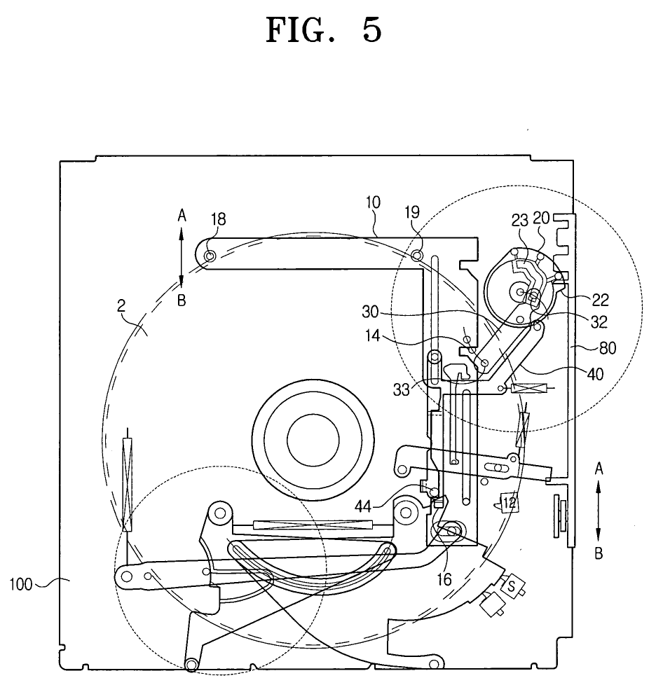

FIG. 5 illustrates the disc guide lever 10 in an intermediate position. Referring to FIG. 5, the second disc 2, being moved in ‘A’ direction and pushing the disc guide lever 10, is guided by the disc guide projections 18 and 19 up to the chucking position. The chucking position can be fixed by the second position controlling groove 16 of the disc guide lever 10 being hitched by the position controlling projection 44 of the locking lever 40. More specifically, as the second position controlling groove 16 is hitched by the position controlling projection 44, the disc guide lever 10 may not move further in the ‘A’ direction. Accordingly, the second disc 2 may not move further either, i.e., the second disc 2 has been moved to the chucking position. When the second disc 2 reaches the chucking position, a dedicated chucking device can perform the chucking operations.

As described above, the slider 80 can keep moving in the ‘B’ direction, even after the chucking operation. As a result, the cam projection part 24, inserted in the cam recess parts 81 of the slider 80, rotates in the ‘C’ direction, thereby rotating the gear cam 20 with respect to the gear cam rotary shaft 21, in the ‘C’ direction.

FIG. 6 illustrates the disc guide lever 10 in a separated position from the second disc 2. Referring to FIG. 6, as the gear cam 20 rotates, the outer projection part 22 of the gear cam 20 can push the locking projection 42 of the locking lever 40, thereby rotating the locking lever 40, with respect to the locking lever rotary shaft 41, in the ‘C’ direction. Consequently, the position controlling projection 44 separates from the second position controlling groove 16 of the disc guide lever 10.

As the gear cam 20 rotates, the guide pin 32 of the releasing lever 30, inserted in the gear cam guide slot 23 of the gear cam 20, moves along the gear cam guide slot 23, and therefore, the releasing lever 30 is rotated, with respect to the releasing lever rotary shaft 31, in the ‘C’ direction. Therefore, the releasing projection 33 of the releasing lever 30 is inserted into the second releasing groove 14 of the disc guide lever 10. If the gear cam 20 makes more rotation in the ‘C’ direction, by a predetermined angle, the disc guide lever 10 can be moved further in the ‘A’ direction, thereby being distanced from the second disc 2.

When the disc guide projections 18 and 19 of the disc guide lever 10 are distanced from the second disc 2, the second disc 2 becomes rotatable on the turntable (not shown), being chucked by the dedicated chucking device (not shown). Thus, loading of the second disc 2 is completed, and the second disc 2 can rotate on the turntable to record or reproduce information by the optical pickup.

For unloading of the second disc 2, the driving motor 121 (shown in FIG. 2) can be counter-rotated to return the slider 80 in the ‘A’ direction. By performing similar processes, in reverse order, the second disc 2 can be discharged to the outside of the housing 130.

As can be appreciated from the above description, by a disc releasing operation, according to an embodiment of the present invention, and the disc drive having the same, the disc guide lever 10 can be released from different sized discs, using a simple-structured gear cam and releasing lever. Therefore, the number of parts and manufacturing costs can be reduced over conventional systems.

Furthermore, an operation of the releasing lever, by the rotation system of the gear cam, can enable a driving load to be minimized, thereby further reducing potential malfunctions typically experienced by conventional systems.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A medium releasing apparatus to separate a medium guide lever from a medium, the medium guide lever selectively capable of guiding differing sized media, the medium releasing apparatus comprising:
a rotatably mounted gear cam;
a locking lever operating in association with the gear cam to selectively lock and release the medium guide lever; and
a releasing lever operating in association with the gear cam to separate the medium guide lever from the medium.

2. The medium releasing apparatus of claim 1, wherein the gear cam is rotatably mounted on a main chassis in a recording and/or reproducing apparatus.

3. The medium releasing apparatus of claim 1, wherein the medium guide lever is mounted on a main chassis of a recording and/or reproducing apparatus.

4. The medium releasing apparatus of claim 1, wherein the medium is a disc.

5. The medium releasing apparatus of claim 1, wherein the gear cam comprises:
at least one cam projection part;
a guide slot to connect with the releasing lever; and
an outer projection part to obstruct movement of the locking lever.

6. The medium releasing apparatus of claim 5, wherein the locking lever comprises a locking projection to be pressed by the outer projection part.

7. The medium releasing apparatus of claim 6, wherein the locking lever is elastically biased by an elastic member which is connected to a main chassis of a recording and/or reproducing apparatus.

8. The medium releasing apparatus of claim 5, wherein the releasing lever comprises a guide pin to move along a path of the guide slot, and a releasing projection to inserted in the medium guide lever.

9. A recording and/reproducing apparatus to load and/or unload at least first and second mediums, the medium loading apparatus comprising:
a main chassis to mount a transfer unit to move the first or second medium;
a power transmission unit comprising a driving motor to transmit power to the transfer unit;
a slider, to be transmitted with the power from the power transmission unit, and movable in directions for loading and/or unloading the first or second medium;
a medium guide lever to be pushed by the first or second medium, thereby guiding the first or second medium;
a pushing lever to connect the slider to the power transmission unit, in association with the medium guide lever; and
a locking/releasing unit to selectively lock and/or separate the medium guide lever from connection with the medium.

10. The recording and/or reproducing apparatus of claim 9, wherein at least one of the first and second mediums is a disc.

11. The recording and/or reproducing apparatus of claim 9, wherein the locking/releasing unit comprises:
a gear cam rotatably mounted to the main chassis and rotated by a reciprocal movement of the pushing lever in connection with the slider;
a locking lever rotatably mounted to the main chassis and associated with the medium guide lever and the gear cam so as to selectively lock and/or release the medium guide lever; and
a releasing lever rotatably mounted to the main chassis and associated with the gear cam so as to separate the medium guide lever from the first or second medium.

12. The recording and/or reproducing apparatus of claim 11, wherein the medium guide lever comprises at least one medium guide projection for guiding the first or second medium by contact with the first or second medium, and moves among an initial position where the medium guide projection has not yet contacted with the first or second medium, an intermediate position where the medium guide projection pushes the first or second medium to a chucking position and a separate position, where the medium guide lever is separated from the first or second medium being in the chucking position, by a predetermined distance.

13. The recording and/or reproducing apparatus of claim 12, wherein the medium guide lever comprises a position controlling groove, and the locking lever comprises a position controlling projection for insertion into the position controlling groove, such that the locking lever locks the medium guide lever.

14. The recording and/or reproducing apparatus of claim 13, wherein the slider comprises a cam recess part, and the gear cam comprises at least one cam projection part for insertion into the cam recess part of the slider, a gear cam guide slot including a predetermined path therein, and an outer projection part formed along an outside of the gear cam slot.

15. The recording and/or reproducing apparatus of claim 14, wherein the locking lever further comprises a locking projection pushed by the outer projection part by rotation of the gear cam, and accordingly, the locking lever is rotated so that the position controlling projection is separated from the position controlling groove of the medium guide lever.

16. The recording and/or reproducing apparatus of claim 15, wherein the releasing lever further comprises a guide pin moving along the path of the guide slot by rotation of the gear cam.

17. The recording and/or reproducing apparatus of claim 16, wherein the medium guide lever comprises a releasing groove,
the releasing lever includes a releasing projection for insertion in the releasing groove, and
the releasing lever is rotated by the movement of the guide pin such that the releasing projection is inserted in the releasing groove.

18. The recording and/or reproducing apparatus of claim 9, where the second medium has a larger width than the first medium.

19. A medium releasing method separating a medium guide lever from a medium, the medium guide lever selectively guiding differing sized media, the medium releasing method comprising:
rotating a gear cam;
selectively locking and releasing the medium guide lever using a locking lever operating based on the rotating of the gear cam; and
separating the medium guide lever from the medium using a releasing lever based on the rotating of the gear cam.

20. The method of claim 19, wherein the medium is a disc.
